(19) United States
(12) Patent Application Publication
(10) Pub. No.: US 2026/0189090 A1
(43) Pub. Date: Jul. 2, 2026

(54) MOTOR FOR A MOBILE ROBOT

(71) Applicant: Boston Dynamics, Inc., Waltham, MA (US)

(72) Inventors: Benjamin G. Katz, Lincoln, MA (US); Adam Lee Young, Arlington, MA (US); Steven Potter, Waltham, MA (US)

(21) Appl. No.: 19/006,484

(22) Filed: Dec. 31, 2024

(51) Int. Cl. H02K 1/30; B25J 9/12; H02K 1/02; H02K 1/14; H02K 1/2783; H02K 3/52; H02K 15/022; H02K 21/16

(52) U.S. Cl. CPC H02K 1/30; B25J 9/126; H02K 1/02; H02K 1/146; H02K 1/2783; H02K 3/522; H02K 15/022; H02K 21/16; H02K 2203/03; H02K 2203/06

(57) ABSTRACT

An electric motor for a mobile robot includes a rotor including a rotor hub and a magnetic structure coupled to the rotor hub. The magnetic structure is configured to provide an active surface. The active surface includes a circular array of radial magnetic poles of alternating polarity. The electric motor further includes a stator comprising a non-segmented structure including a set of teeth and a set of slots arranged between individual teeth of the set of teeth, wherein each tooth of the set of teeth has a surface over which a respective coil is configured to be placed within adjacent slots of the tooth. The electric motor further includes a set of coils arranged within the set of slots of the stator, and a printed circuit board electrically coupled to each of the coils in the set of coils.

### FIELD OF THE INVENTION

This disclosure relates generally to robotics and more specifically to the design of a high performance motor for a mobile robot.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, propellers/rotors, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

A variety of settings today demand high levels of automation, e.g., factories, transportation facilities, material handling facilities and warehouses, among others. At least some of the automation in such environments may be provided by robots that can perform tasks, such as moving objects (e.g., automobile parts) from a first location to a second location (e.g., a so-called “pick and place” operation), lifting heavy objects, etc. While certain types of tasks in such environments may be performed by robots mounted at a fixed location or mobile wheeled robots, other tasks may be more well-suited for robots with legs. Humanoid robots may be legged robots that include components (e.g., feet, arms, torso, head, hands) modeled after the human form with members connected by joints that enable the members to rotate with one or more degrees of freedom about the joint.

Robots (e.g., humanoid robots) employ actuators to move their appendages. Actuators can account for a large portion of the overall cost of the robot, and the capability, agility and payload capacity of a robot often depends on the actuators' performance. Geared electric motors are frequently used as actuators in robots. The gearing enables the motor to operate at higher speed and lower torque, which may be favorable for providing high power output with less mass and lower losses. The inventors have recognized and appreciated that some conventional geared electric motors are unable to provide sufficient torque per mass required to perform certain maneuvers and/or execution of various tasks (e.g., lifting and walking with heavy objects) that a robot may be expected to perform in a warehouse environment. Additionally, some conventional geared electric motors have high inertia and/or require extra torque to accelerate and decelerate the rotors. Some embodiments relate to a motor architecture for a robot that enables high peak torque, while reducing (e.g., minimizing) mass, inertia and power dissipation.

In some embodiments, the invention features an electric motor for a mobile robot. The electric motor includes a rotor including a rotor hub and a magnetic structure coupled to the rotor hub, wherein the magnetic structure is configured to provide an active surface, the active surface including a circular array of radial magnetic poles of alternating polarity, a stator comprising a non-segmented structure including a set of teeth and a set of slots arranged between individual teeth of the set of teeth, wherein each tooth of the set of teeth has a surface over which a respective coil is configured to be placed within adjacent slots of the tooth, a set of coils arranged within the set of slots of the stator, and a printed circuit board electrically coupled to each of the coils in the set of coils.

In one aspect, the active surface is an outside diameter of the rotor. In another aspect, the active surface is an inside diameter of the rotor. In another aspect, the magnetic structure includes a set of permanent magnets arranged around the rotor hub in a Halbach array. In another aspect, the set of permanent magnets includes at least two types of magnets magnetized in different orientations, wherein the at least two types of magnets are arranged around the rotor in a repeating sequence. In another aspect, the set of permanent magnets includes at least five types of magnets magnetized in different orientations, wherein the at least five types of magnets are arranged around the rotor in a repeating sequence. In another aspect, the set of permanent magnets comprises a set of sintered rare-earth magnets. In another aspect, the set of sintered rare-earth magnets includes a set of samarium-cobalt magnets or a set of NbFeB magnets. In another aspect, the set of permanent magnets are arranged to form at least ten pole pairs. In another aspect, the magnetic structure is configured to provide an active surface having a number of pole pairs greater than X, where X is 2*sqrt (diameter of active surface).

In another aspect, the magnetic structure includes a polar anisotropic ring magnet. In another aspect, the rotor hub comprises a lightweight hub comprising a low-density structural material. In another aspect, the low-density structural material includes one or more of aluminum, titanium, plastic, or a fiber reinforced material. In another aspect, the rotor hub includes a drum and a web portion coupled to the drum. In another aspect, the magnetic structure is bonded to the drum. In another aspect, the drum includes a relieved portion that is not bonded to the magnetic structure. In another aspect, the electric motor further includes a foam material arranged between the magnetic structure and the relieved portion of the drum. In another aspect, the electric motor further includes a dimpled metal structure form between the drum and the magnetic structure. In another aspect, the drum includes one or more partial or complete through features formed in the drum configured to reduce a radial stiffness of the drum. In another aspect, the one or more partial or complete through features comprises a set of slits formed in the drum. In another aspect, the drum has a non-uniform surface structure. In another aspect, the rotor hub includes a drum and the magnetic structure is bonded to the drum using a foaming adhesive.

In another aspect, the stator comprises steel. In another aspect, the stator comprises high cobalt steel. In another aspect, the set of teeth of the stator comprises a set of straight teeth. In another aspect, the set of coils comprises a set of copper coils. In another aspect, each coil in the set of coils includes fifteen or fewer turns. In another aspect, each coil in the set of coils includes ten or fewer turns. In another aspect, the set of coils includes a trapezoidal shaped coil and a straight coil. In another aspect, the set of coils includes trapezoidal shaped and straight coils alternating around a circumference of the stator. In another aspect, a cross sectional area and number of turns of the trapezoidal shaped coil and the straight coil are approximately equal. In another aspect, the electric motor further includes an epoxy configured to pot the set of coils into the set of slots of the stator. In another aspect, the printed circuit board is configured to electrically couple groups of coils in the set of coils in series and/or parallel in a delta configuration or a wye configuration. In another aspect, the printed circuit board is configured to electrically couple groups of coils in the set of coils in series in a wye configuration. In another aspect, each of the coils includes a lead configured to be inserted into a corresponding radial slot in the printed circuit board. In another aspect, the lead of each of the coils is chamfered.

In some embodiments, the invention features a stator for an electric motor. The stator includes a non-segmented metal support comprising a set of straight teeth and a set of slots between the set of straight teeth, a set of coils, and a fixing component. Each coil in the set of coils is formed from square or rectangular copper wire into a single layer with fifteen or fewer turns, and arranged on a corresponding straight tooth of the non-segmented metal support such that the coil occupies corresponding slots in the set of slots on either side of the straight tooth. The fixing component is configured to secure the set of coils into the set of slots.

In one aspect, the stator further includes a printed circuit board, and each coil in the set of coils includes a first lead and a second lead, each of the first lead and the second lead being electrically coupled to the printed circuit board. In another aspect, the printed circuit board is a ring-shaped printed circuit board. In another aspect, the ring-shaped printed circuit board includes an inner diameter and an outer diameter, the printed circuit board includes a first set of notches located on an inner diameter of the printed circuit board and a second set of notches located on an outer diameter of the printed circuit board, and for each coil in the set of coils, the first lead is electrically coupled to the printed circuit board in a corresponding notch in the first set of notches, and the second lead is electrically coupled to the printed circuit board in a corresponding notch in the second set of notches. In another aspect, the printed circuit board is configured to electrically couple the set of coils into groups of coils in a delta configuration or a wye configuration. In another aspect, the printed circuit board is configured to electrically couple the set of coils into groups of coils in a wye configuration by electrically coupling every third coil in the set of coils in series. In another aspect, the fixing component is configured to secure the set of coils into the set of slots via solder connections between each of the first lead and the second lead of each coil and the printed circuit board.

In another aspect, the non-segmented metal support comprises steel. In another aspect, the non-segmented metal support comprises high cobalt steel. In another aspect, each tooth in the set of straight teeth has a taper along its length of no more than five degrees. In another aspect, the set of coils includes a trapezoidal shaped coil and a straight coil. In another aspect, a fill factor of the set of coils arranged in the set of slots is at least 60%. In another aspect, a cross-section of the rectangular copper wire includes a small edge and a large edge larger than the small edge, and each coil in the set of coils is formed in a single layer from rectangular copper wire wound on the small edge. In another aspect, each coil in the set of coils is formed in a single layer including 180 degree bends in the copper wire. In another aspect, the fixing component comprises an epoxy. In another aspect, the fixing component comprises an end cap arranged on the non-segmented metal support to secure the set of coils into the set of slots.

In some embodiments, the invention features a method of manufacturing a stator for an electric motor. The method includes forming a non-segmented metal support comprising a set of straight teeth and a set of slots between the set of straight teeth, forming square or rectangular copper wire into a single layer with fifteen or fewer turns to produce a set of coils, placing each coil of the set of coils over a corresponding straight tooth of the non-segmented metal support, such that the coil occupies corresponding slots in the set of slots on either side of the straight tooth, and securing the set of coils into the set of slots using a fixing component.

In one aspect, each coil in the set of coils includes a first lead and a second lead, and the method further includes electrically coupling each of the first lead and the second lead of each coil to a printed circuit board. In another aspect, the printed circuit board is a ring-shaped printed circuit board. In another aspect, the ring-shaped printed circuit board includes an inner diameter and an outer diameter, the printed circuit board includes a first set of notches located on an inner diameter of the printed circuit board and a second set of notches located on an outer diameter of the printed circuit board, and electrically coupling each of the first lead and the second lead of each coil to the printed circuit board comprises for each coil in the set of coils, electrically coupling the first lead to the printed circuit board in a corresponding notch in the first set of notches, and electrically coupling the second lead to the printed circuit board in a corresponding notch in the second set of notches. In another aspect, the printed circuit board is configured to electrically couple the set of coils into groups of coils in a delta configuration or a wye configuration. In another aspect, the printed circuit board is configured to electrically couple the set of coils into groups of coils in a wye configuration by electrically coupling every third coil in the set of coils in series. In another aspect, securing the set of coils into the set of slots using a fixing component comprises soldering the first lead and the second lead of each coil to the printed circuit board.

In another aspect, forming a non-segmented metal support comprises forming the non-segmented metal support from steel. In another aspect, forming the non-segmented metal support from steel comprises forming the non-segmented metal support from high cobalt steel. In another aspect, forming the non-segmented metal support comprising a set of straight teeth comprises punching out and/or laser cutting the set of straight teeth. In another aspect, forming the non-segmented metal support comprises forming the non-segmented metal support using an additive manufacturing process. In another aspect, the set of coils includes a trapezoidal shaped coil and a straight coil. In another aspect, placing each coil of the set of coils over a corresponding straight tooth of the non-segmented metal support, such that the coil occupies a corresponding slot in the set of slots comprises placing each coil such that the set of slots has a fill factor of at least 60%.

In another aspect, a cross-section of the rectangular copper wire includes a small edge and a large edge larger than the small edge, and wherein forming square or rectangular copper wire into a single layer with fifteen or fewer turns to produce a set of coils comprises winding rectangular copper wire on the small edge. In another aspect, forming square or rectangular copper wire into a single layer with fifteen or fewer turns to produce a set of coils comprises forming 180 degree bends in the copper wire. In another aspect, forming 180 degree bends in the copper wire comprises overbending the copper wire to account for springback along a length of the coil.

In another aspect, securing the set of coils into the set of slots using a fixing component comprises potting the set of coils into the set of slots using an epoxy. In another aspect, securing the set of coils into the set of slots using a fixing component comprises attaching an end cap on the non-segmented metal support to secure the set of coils into the set of slots.

In some embodiments, the invention features an electric motor including a stator designed in accordance with one or more of the techniques described herein. In some embodiments, the invention features a robot including an electric motor designed in accordance with one or more of the techniques described herein. In some embodiments, the robot is a humanoid robot.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 shows an example configuration of a robotic device, according to an illustrative embodiment of the invention.

FIG. 2A shows an example of a humanoid robot, according to an illustrative embodiment of the invention.

FIG. 2B shows an example of various actuators of a humanoid robot, according to an illustrative embodiment of the invention.

FIGS. 3A and 3B illustrate a respective rotor and stator for an example inrunner motor design.

FIGS. 3C and 3D illustrate a respective rotor and stator for an example outrunner motor design.

FIG. 4A schematically shows an example rotor of an electric motor for a robotic device, according to an illustrative embodiment of the invention.

FIG. 4B schematically shows a cross-section through the example rotor of FIG. 4A.

FIG. 4C schematically illustrates a polar anisotropic ring magnet that may be used with a rotor of an electric motor for a robotic device, according to an illustrative embodiment of the invention.

FIG. 5A schematically shows a first structure of a magnet mounted on a lightweight hub, according to an illustrative embodiment of the invention.

FIG. 5B schematically shows a second structure of a magnet mounted on a lightweight hub, according to an illustrative embodiment of the invention.

FIG. 6A shows a first example stator of an electric motor for a robotic device, according to an illustrative embodiment of the invention.

FIG. 6B shows a second example stator of an electric motor for a robotic device, according to an illustrative embodiment of the invention.

FIG. 6C shows a third example stator of an electric motor for a robotic device, according to an illustrative embodiment of the invention.

FIG. 7 shows an example stator of an electric motor in which the coils of the stator are coupled to a printed circuit board, according to an illustrative embodiment of the invention.

FIG. 8 is a flowchart of a process for manufacturing a stator of an electric motor for a robotic device, according to an illustrative embodiment of the invention.

### DETAILED DESCRIPTION

The performance of motors/actuators in robotic devices is often a large driver of overall robot performance. Humanoid robots include a number of actuators (e.g., 2-5 actuators) coupled to members of a robotic limb that facilitate movement of the robotic limb through a range of motion limited by the joints connecting the members. To achieve a desired level of performance, the actuators of a humanoid robot may require a high peak torque output in a lightweight and compact form factor (e.g., small diameter). Some existing actuator designs used in robotic devices are not configured to generate sufficient torque per mass of the actuator to achieve the desired robotic limb movements of the robot. Additionally, although large form factor actuators capable of generating large peak torques may be designed using some existing techniques, the large actuator size increases the overall bulkiness and weight of the robot, rendering such robots less appealing for performing a wide range of tasks in an environment, such as a warehouse. To this end, some embodiments of the present disclosure relate to a motor architecture configured to provide high peak torques in a low mass, low inertia and low power dissipation (e.g., power dissipation due to resistive losses) design.

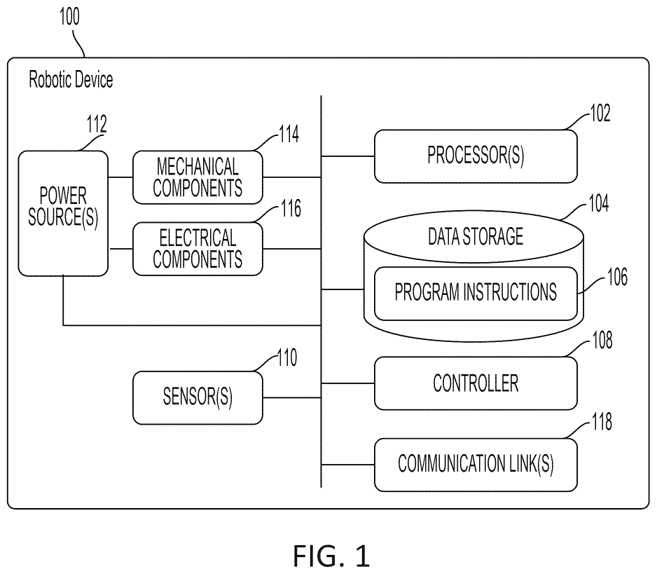

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

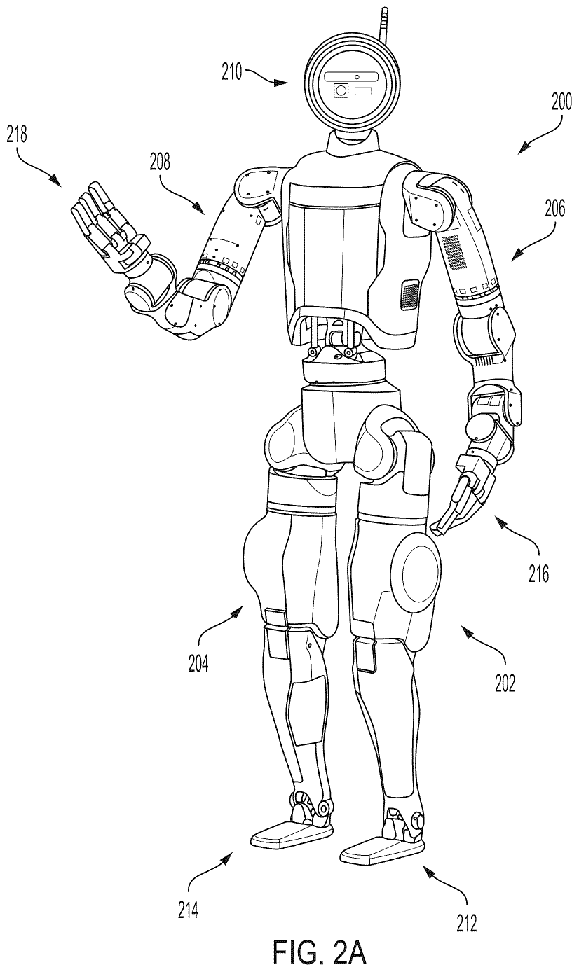

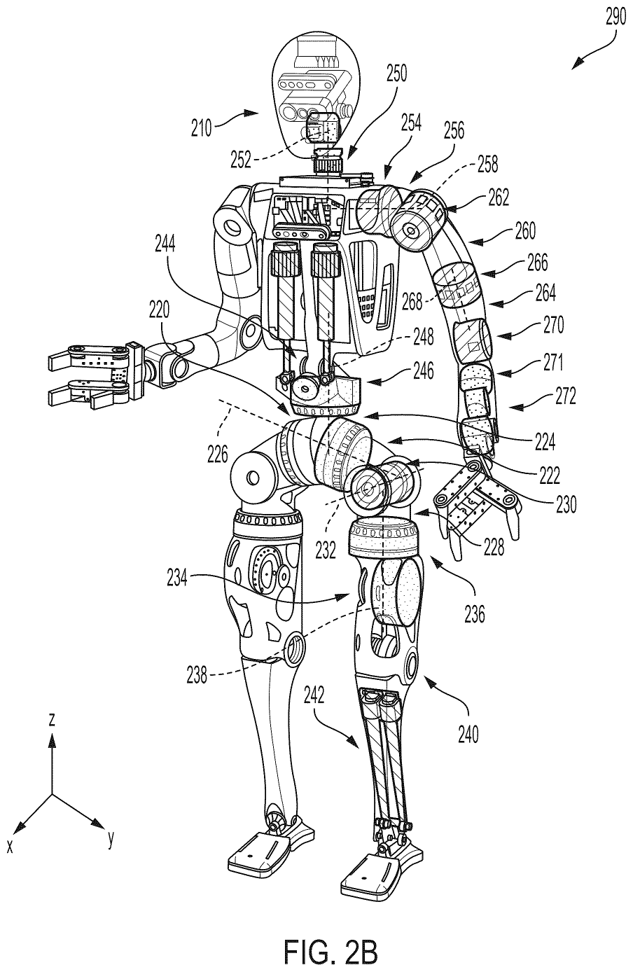

FIG. 2A illustrates an example of a humanoid robot, according to an illustrative embodiment of the invention. The robot 200 may correspond to the robotic device 100 shown in FIG. 1. The robot 200 serves as a possible implementation of a robotic device that may be configured to include the systems and/or carry out the methods described herein. Other example implementations of robotic devices may exist.

The robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of (e.g., one, two, three or more) members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms. In some embodiments, one or more sensors (e.g., cameras, infrared sensors, object sensors, range sensors, etc.) may be arranged on an arbitrary member or link of the robot.

Robot 200 may also include sensors to measure the angles of the joints of its articulated appendages. In addition, the articulated appendages may include a number of actuators that can be controlled to extend and retract members of the articulated appendages. Examples of actuators that may be included in robot 200 are described in more detail in FIG. 2B. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

In some embodiments, robot 200 may include a set of continuous rotation joints, where each continuous rotation joint permits continuous (e.g., 360 degree and/or limitless) rotation about a corresponding axis. Rather than requiring such joints to “unwind” by, for example, always determining a target joint angle relative to a nominal (e.g., 0 degree) orientation, a control system of the robot 200 may be configured to determine that the target joint angle be set at any multiple of 360 degrees (e.g., 0 degrees, 360 degrees, 720 degrees) to permit efficient movement of an attached member about the joint to achieve the target joint angle. For instance, if a target joint angle of a continuous rotation joint is 15 degrees and the current joint angle is 350 degrees, rather that rotating an attached member-335 degrees about the joint, the attached member can instead be rotated +25 degrees (to 375 degrees), which is equivalent to a joint angle of 15 degrees for a continuous rotation joint.

In some embodiments, robot 200 may include a body (e.g., a torso and a base such as a pelvis base) and one or more kinematic chains of robot members (e.g., arms, legs) coupled to the body. Each of the plurality of kinematic chains of robot members may include at least two joints (e.g., a first joint coupling the kinematic chain to the body and a second joint coupling at least two members of the kinematic chain). At least one of the at least two joints in a kinematic chain may be a continuous rotation joint that enables continuous rotation of at least one of the members (and possibly all members if the joint that couples the kinematic member to the body is a continuous rotation joint) of the kinematic chain about the joint.

Robot 200 may be configured to send sensor data from the articulated appendages to a device coupled to robot 200 such as a processing system, a computing system, or a control system. Robot 200 may include a memory, either included in a device on robot 200 or as a standalone component, on which sensor data is stored. In some implementations, the sensor data is retained in the memory for a certain amount of time. In some cases, the stored sensor data may be processed or otherwise transformed for use by a control system on robot 200. In some cases, robot 200 may also transmit the sensor data over a wired or wireless connection (or other electronic communication means) to an external device.

FIG. 2B illustrates an example of a humanoid robot 290, according to an illustrative embodiment of the invention. Humanoid robot 290 may include components (e.g., arms, legs, feet, head) similar to robot 200 of FIG. 2A, which may not be relabeled in FIG. 2B to reduce clutter. Overlaid on the depiction of humanoid robot 290 are a set of actuators that may be used to move an attached member at corresponding joints of the humanoid robot 290 to enable movement of the robot. As described in more detail below, humanoid robot 290 may include different types of actuators and joints that enable different members of the robot to move with varying degrees of freedom, permitting flexibility of movement when desired while restricting movement as appropriate to, for example, avoid or reduce the risk of collisions between robot components.

Humanoid robot 290 includes a base member (e.g., a pelvis base, as shown in FIG. 2B) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate leg member 228. An electric actuator 230 may be disposed between the first hip member 222 and the first intermediate leg member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate leg member 228. The electric actuator 230 may be configured to rotate the first hip member 222 relative to the first intermediate leg member 228 about an axis (e.g., a first hip-x axis) 232. The first intermediate leg member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 234. The electric actuator 236 may be configured to rotate the first intermediate leg member 228 relative to the first leg member 234 about an axis (e.g., a first hip-z axis) 238. In some embodiments, a second hip member, second intermediate leg member, and second leg member are connected in similar fashion to the first hip member, first intermediate leg member, and first leg member, using similar actuators rotating along similar additional axes and/or providing similar independently actuatable degrees of freedom.

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. FIG. 2B shows a set of reference axes to illustrate the x, y and z directions, although the actual x, y, and z axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, the leg member 234 is an upper leg member, which may in turn be connected to a lower leg member 242 at a knee joint 240. In some embodiments, the lower leg member 242 is connected to a foot (e.g., foot 212) at an ankle joint.

In some embodiments, the pelvis base 220 is rotatably connected and/or configured to be rotatably connected to a back member 244 (also referred to herein as a “torso”) of the robot 290. An electric actuator 246 may be disposed between the pelvis base 220 and the back member 244 (e.g., in, between, connected to, and/or part of one or both components). In some embodiments, a first portion of the electric actuator 246 may be fixed to the pelvis base 220, and a second portion of the electric actuator 246 may be fixed to the back member 244. The electric actuator 246 may be configured to rotate the back member 244 relative to pelvis base 220 about an axis (e.g., back-z axis) 248. In some embodiments, the back member 244 is rotatably connected and/or configured to be rotatably connected to a head 210 of the robot 290. An electric actuator 250 may be disposed between the back member 244 and the head 210 (e.g., in, between, connected to, and/or part of one or both components). In some embodiments, a first portion of the electric actuator 250 may be fixed to the head 210 and a second portion of the electric actuator 250 may be fixed to the back member 244. The electric actuator 250 may be configured to rotate the head 210 relative to the back member 244 about an axis (e.g., neck-z axis) 252.

In some embodiments, a first shoulder member 256 is rotatably connected and/or configured to be rotatably connected to a back member 244 of the robot 290. An electric actuator 254 may be disposed between the back member 244 and the first shoulder member 256 (e.g., in, between, connected to, and/or part of one or both components). In some embodiments, a first portion of the electric actuator 254 may be fixed to the first shoulder member 256, and a second portion of the electric actuator 254 may be fixed to the back member 244. The electric actuator 254 may be configured to rotate the first shoulder member 256 relative to the back member 244 about an axis (e.g., shoulder-y axis) 258. In some embodiments, the first shoulder member 256 is rotatably connected and/or configured to be rotatably connected to a first intermediate arm member 260 of the robot 290. An electric actuator 262 may be disposed between the first shoulder member 256 and the first intermediate arm member 260 (e.g., in, between, connected to, and/or part of one or both components). In some embodiments, a first portion of the electric actuator 262 may be fixed to the first intermediate arm member 260, and a second portion of the electric actuator 262 may be fixed to the first shoulder member 256. The electric actuator 262 may be configured to rotate the first intermediate arm member 260 relative to the first shoulder member 256 about an axis to provide adduction/abduction of the first intermediate arm member 260 relative to the first shoulder member 256. In some embodiments, a first upper arm member 264 is rotatably connected and/or configured to be rotatably connected to the first intermediate arm member 260 of the robot 290. An electric actuator 266 may be disposed between the first arm member 264 and the first intermediate arm member 260 (e.g., in, between, connected to, and/or part of one or both components). In some embodiments, a first portion of the electric actuator 266 may be fixed to the first arm member 264, and a second portion of the electric actuator 266 may be fixed to the first intermediate arm member 260. The electric actuator 266 may be configured to rotate the first arm member 264 relative to the first intermediate arm member 260 about an axis (e.g., shoulder-z axis) 268.

In some embodiments, the first arm member 264 may in turn be connected to a first lower arm member 272 at a first elbow joint. An electric actuator 270 may be disposed between the first arm member 264 and the first lower arm member 272 (e.g., in, between, connected to, and/or part of one or both components). In some embodiments, a first portion of the electric actuator 270 may be fixed to the first arm member 264, and a second portion of the electric actuator 270 may be fixed to the first lower arm member 272. The electric actuator 270 may be configured to rotate the first arm member 264 relative to the first lower arm member 272 about an axis that provides flexion/extension of the first lower arm member 272 relative to the first arm member 264. In some embodiments, rotation about the first elbow joint may be greater than 90 degrees. In some embodiments, rotation about the first elbow joint may be greater than 180 degrees.

In some embodiments, the first lower arm member 272 is connected to an end effector (e.g., a gripper or hand) via a wrist component. The wrist component may contain one or more actuators configured to provide various ranges of motion to the wrist of the robot. In some embodiments, a second shoulder member, second intermediate arm member, second upper arm member, and second lower arm member are connected in similar fashion to the first shoulder member, first intermediate arm member, first upper arm member, and first lower arm member using similar actuators rotating along similar additional axes and/or providing similar independently actuatable degrees of freedom.

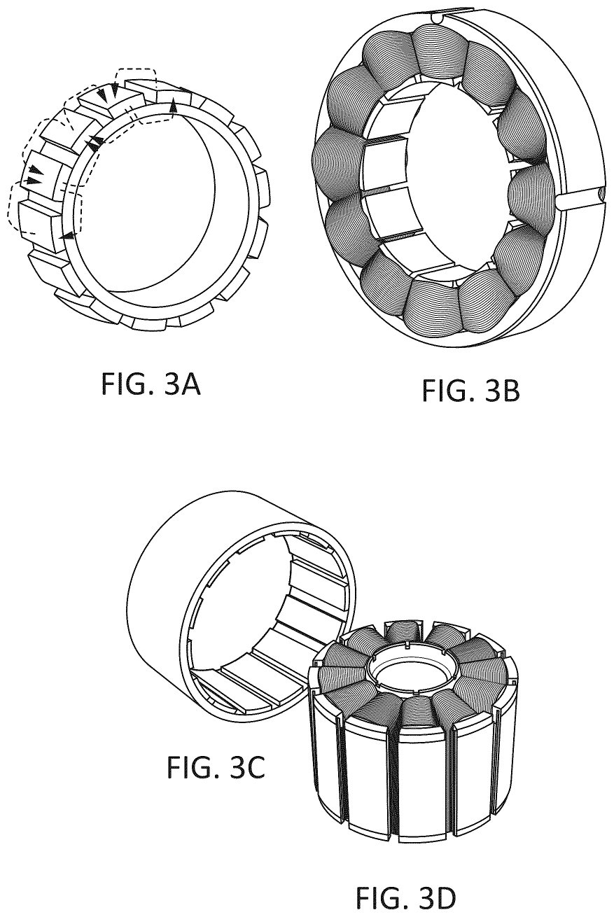

As described above, the performance of electric actuators/motors in robotic devices is often a large driver of overall robot performance. Electric motors used in robot applications include a stator configured to generate a magnetic field and a rotor configured to rotate relative to the stator. FIGS. 3A and 3B illustrate examples of a rotor and stator, respectively, for a conventional inrunner surface permanent magnet motor using radially oriented magnets bonded to the outer diameter of a steel ring. FIGS. 3C and 3D illustrate examples of a rotor and stator, respectively, for a conventional outrunner surface permanent magnet motor using radially oriented magnets bonded to the inner diameter of a steel ring.

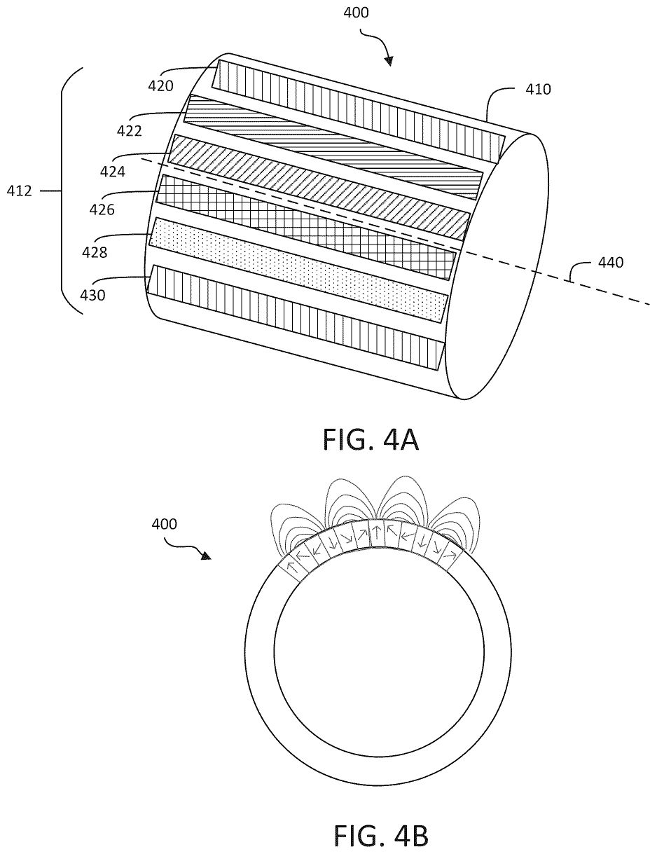

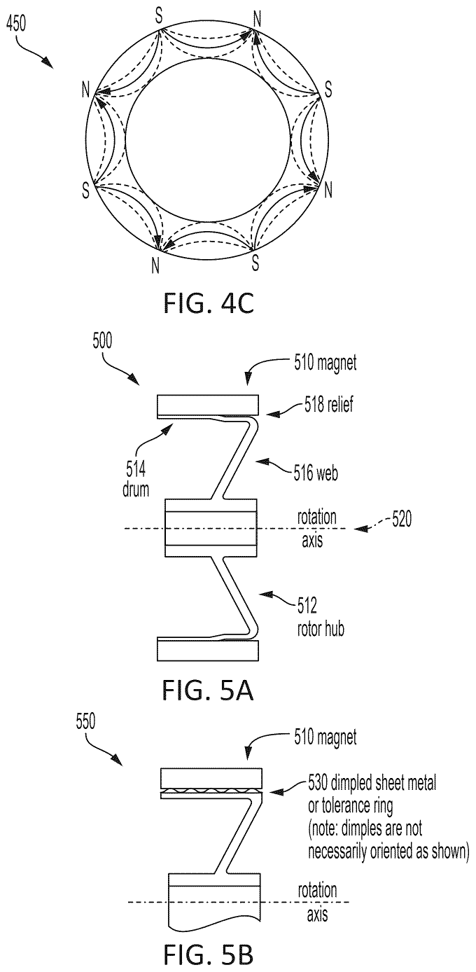

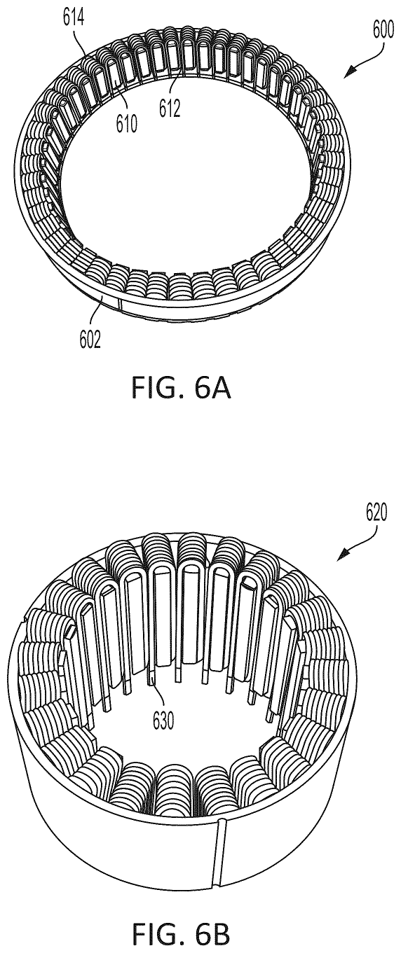

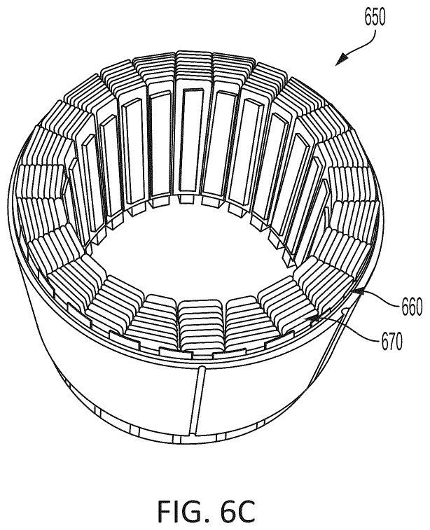

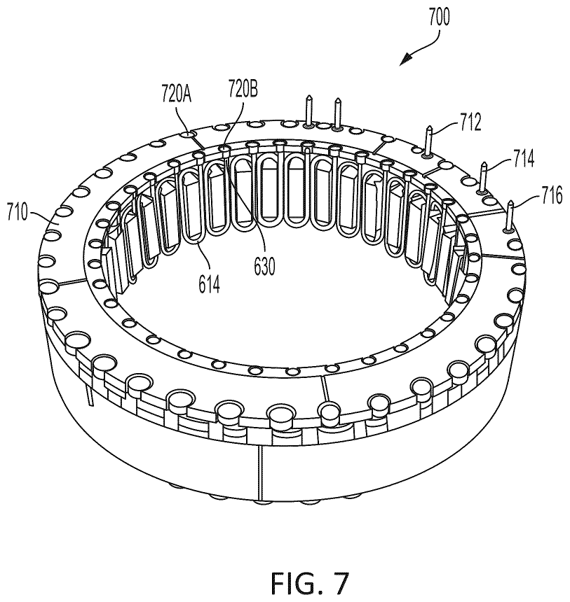

The inventors have recognized and appreciated that the geometry and/or characteristics of the motor including the stator and the rotor geometry may be designed (e.g., optimized) to provide a motor architecture capable of generating high peak torques in a low mass, low inertia, and low power dissipation package. Such actuators may be useful in permitting a robot (e.g., robot 200) to perform a wide variety of tasks. FIGS. 4A-5B describe example rotor architectures that may be used in an electric motor, in accordance with some embodiments, and FIGS. 6A, 6B and FIG. 7 describe example stator architectures that may be use in an electric motor, in accordance with some embodiments. It should be appreciated that the rotors shown in FIGS. 4A-5B and the stators shown in FIGS. 6A, 6B and FIG. 7 are merely exemplary and some embodiments of the present disclosure may include rotor and/or stator designs other than those illustrated.

In some embodiments, a rotor of an electric motor includes a magnetic structure formed as a multi-pole Halbach ring magnet. Such a multi-pole Halbach ring magnet produces a magnetic field having a magnetic flux density (field strength) that is greater on one side of the magnet (e.g., the outside for an inrunner motor), resulting in a magnetic structure having a field strength that surpasses that of an identical radial-anisotropic (radially magnetized ring magnet). Such a multi-pole Halbach ring magnet may be implemented, for example, as a bonded/segmented Halbach array design, an example of which is shown in FIGS. 4A and 4B or a polar anisotropic ring magnet, an example of which is shown in FIG. 4C. Although the example rotor and stator designs described herein are shown as components of an inrunner motor design, it should be appreciated that other embodiments may be implemented as components for an outrunner motor design.

FIG. 4A schematically illustrates a rotor 400 of an electric motor, in accordance with some embodiments. Rotor 400 includes a rotor hub 410 and a magnetic structure 412 coupled to the rotor hub 410. The magnetic structure 412 may be configured to generate a magnetic field resembling that shown in FIG. 4B, where the field lines associated with the magnetic field emanate approximately radially from the poles of the magnetic structure 412. In some embodiments, the rotor hub 310 may be implemented as a metal structure (e.g., steel) formed as a ring. In the example rotor 400 shown in FIG. 4A, magnetic structure 412 includes a set of permanent magnets arranged in a circular array around the rotor hub 410. For example, the set of permanent magnets may include magnets 420, 422, 424, 426, 428, 430, etc. Although only a subset of magnets is shown in FIG. 4A, it should be appreciated that the magnets may continue around the entirety of the circumference of the rotor 400. As indicated by the different cross-hatching in FIG. 4A, different permanent magnets in the set of permanent magnets may have different magnetizations. In some embodiments, the magnetizations of the individual permanent magnets may be arranged in a repeating pattern to form a segmented Halbach array. In the example shown in FIG. 4A, the repeating pattern includes five permanent magnets having different magnetizations (i.e., magnet 420 and magnet 430 have the same magnetization). It should be appreciated however, that any suitable number of permanent magnets may be included in the repeating structure of the Halbach array configuration, and embodiments are not limited in this respect. Such a Halbach array configuration of the magnetic structure 412 may result in the magnetic field produced by the magnetic structure 412 being stronger on one side of the magnetic structure 312. For instance, each group of repeating elements in the Halbach array configuration for an inrunner motor shown in FIG. 4A may generate a magnetic field that is stronger on the outside of the rotor 400 (i.e., away from the rotation axis 440 of rotor 400). The surface of the rotor where the magnetic flux is stronger may be referred to herein as an “active surface,” with the active surface providing a circular array of radial magnetic poles of alternating polarity. Such a Halbach array configuration may generate a magnetic field that is stronger than can be achieved with radially magnetized magnets included in a rotor of comparable size. The stronger magnetic field achievable using the Halbach array configuration may result in a motor with a higher torque to mass ratio and/or less power dissipation than radially magnetized magnet designs. Additionally, such a Halbach array configuration may have less inertia compared with radially magnetized magnet designs which require a steel flux-return path. As shown in FIG. 4A, the set of permanent magnets in the magnetic structure 412 may be outward facing on the rotor 400 in some embodiments for use in an inrunner motor design.

In some embodiments, each of the magnets in the set of permanent magnets in the magnetic structure 412 (e.g., including magnets 420, 422, 424, 426, 428, 430) may be magnetized individually (or in groups of similarly magnetized magnets) and the magnetized magnets may be affixed (e.g., glued) to the rotor hub 410 in the desired Halbach array configuration. In some embodiments, the rotor 400 includes a high number of pole pairs formed by the magnetic structure 412. For instance, in some embodiments, the rotor 300 includes at least 10 pole pairs, at least 12 pole pairs, at least 15 pole pairs, at least 20 pole pairs, at least 25 pole pairs, at least 30 pole pairs, etc. In some embodiments, the number of pole pairs is divisible by 7. On the one hand, increasing the number of pole pairs may provide some advantages relative to magnetic structures with fewer pole pairs (e.g., the magnets of magnetic structure 412 may have smaller radial thickness, the steel of the stator bridging between teeth of the stator may be thinner, the axial length associated with the end-turns of copper in the slots of the stator may be reduced). On the other hand, increasing the number of pole pairs may also increase the manufacturing complexity of the rotor 400 by requiring a larger number of permanent magnets in magnet structure 412. Although including a large number of permanent magnets in magnet structure 412 may also be achieved by increasing the diameter of the rotor hub 410 and keeping the size of the magnets the same, increasing the diameter of the rotor hub may also increase the size and/or mass of the rotor, resulting in a motor design that may be too bulky and/or heavy for some robotic applications. In some embodiments, the rotor 400 includes a higher number of pole pairs per rotor diameter (e.g., outer diameter) compared with rotors used in some conventional electric motor designs. In some embodiments, the number of poles scales with the square root of diameter of the active surface (e.g., outer diameter) of the rotor. In one example, the permanent magnets in the magnetic structure may be arranged to form a number of pole pairs corresponding to, approximately, or greater than 2*sqrt (diameter of active surface of rotor in mm). In another example, the permanent magnets in the magnetic structure may be arranged to form a number of pole pairs corresponding to or approximately 1.76*(diameter of active surface of rotor in mm)^{0.6}. It should be appreciated that in some embodiments, any other suitable relationship between number of pole pairs and diameter of the active surface may alternatively be used. In some embodiments, the permanent magnets in the magnetic structure 412 may be implemented as thin slivers of magnetic material coupled to the rotor hub 410. In some embodiments, the set of permanent magnets included in magnetic structure 412 includes a set of sintered NdFeB magnets.

The example rotor 400 shown in FIG. 4A includes a rotor hub 410, which may typically be made of steel or another strong metal alloy, which may add a substantial amount of mass to the rotor and overall motor architecture. Some embodiments include a rotor design that employs a lightweight rotor hub to reduce the mass of the rotor. For example, some embodiments may include a rotor hub made of an aluminum alloy substrate, carbon fiber, fiberglass reinforced plastic or some other lightweight strong material. Such a lightweight rotor hub design may be possible, in part, because a steel flux-return ring as used with radially magnetized magnets may not be required. Examples of embodiments that employ a lightweight rotor hub design may substitute a polar anisotropic ring magnet as the magnetic structure 412 in place of the segmented array configuration of permanent magnets shown in FIG. 4A. FIG. 4B shows a cross section through the rotor 400, which includes a segmented Halbach array configuration for magnetic structure 412 as shown in FIG. 4A.

In some embodiments, rather than using the segmented magnet design shown in FIG. 4A, a polar anisotropic ring magnet may be used as a magnetic structure 412 of a rotor in an electric motor. Similar to the magnetic field generated by the Halbach array configuration shown in the segmented design of FIGS. 4A and 4B, a polar anisotropic ring magnet is configured to generate a magnetic field in which the magnetic flux density (field strength) is stronger on one side of the magnet (e.g., the outside of the magnet for an inrunner motor design). FIG. 4C shows a cross sectional view through a polar anisotropic ring magnet 450, in accordance with some embodiments.

In some embodiments, a lightweight rotor hub may be used as a rotor support structure rather than a steel ring. For instance, the lightweight rotor hub may be formed of a low-density structural material examples of which include, but are not limited to, aluminum, titanium, plastic, or a fiber reinforced material (e.g., glass fiber reinforced polymer). A potential challenge with manufacturing a lightweight rotor hub includes the presence of thermal stresses at the interface between the magnet and the low-density structural material. For example, sintered NdFeB ring magnets may be brittle and/or have undetected internal cracks. Such magnets may also have a coefficient of thermal expansion (CTE) that is considerably lower than the CTE of the low-density structural material of the lightweight hub. If the ring magnet is bonded to the lightweight hub at room temperature and is then heated (as in a motor application), the difference in CTE between the two types of materials may cause the hub material to expand faster than the magnet, which may cause the magnet to crack. Alternatively, if the ring magnet is bonded to the hub and cured at a high temperature, the difference in CTE may cause the hub material to contract more when cooled, which may put the adhesive bond between the magnet and the hub material into radial tension, possibly resulting in separation of the bond.

Some embodiments of the present disclosure, examples of which are shown in FIGS. 5A and 5B, relate to rotors including lightweight rotor hub designs configured to reduce thermal stress at the interface between the ring magnet and the low-density structural material of the lightweight hub. FIG. 5A shows an example of a rotor 500 including a magnet (e.g., a polar anisotropic ring magnet) coupled to a lightweight rotor hub 512. As shown in FIG. 5A, the rotor hub 512 may include a drum 514 and a web portion 516 coupled to the drum 514. The drum 514 may be a thin-walled structure that is coupled (e.g., bonded using glue, a foaming adhesive, or other suitable adhesive) to the magnet 510 and may include a relieved portion 518 that is not coupled (e.g., not bonded) to the magnet 510. In some embodiments, the magnet 510 makes an interference fit to the drum. As shown in FIG. 5A, the relieved portion 518 may leave a gap between that portion of the drum 514 and the magnet 510. In some embodiments, at least a portion of the gap between the relieved portion 518 and the magnet 510 may be filled with a foam material. Introduction of the gap formed by the relieved portion 518 may serve to lessen thermal stresses on the bonded interface between the drum 514 and the magnet 510 during fluctuations in temperature of the rotor 500.

In some embodiments, the drum 514 may include one or more modifications to further minimize thermal stress at the interface between the drum 514 and the magnet 510. For instance, the drum 514 may include one or more partial or complete through features to reduce radial strength of the drum. For instance, a set of through slots may be formed in the drum 514. In some embodiments, the drum 514 may have a non-uniform surface structure. For instance, the drum 514 may include slits, corrugations, and/or dimples to vary the contact surface between the drum 514 and the magnet 510. In some embodiments, the drum 514 may be bonded to the magnet 510 using a foaming adhesive to, for example, reduce the bulk modulus of the material at the interface between the drum 514 and the magnet 510. In some embodiments, a layer of polymer foam may be disposed between (e.g., bonded to) the magnet 510 and the drum 514. In some embodiments, the magnet 510, foam, and drum 514 form an interference fit. In some embodiments, a torsional deflection of the magnet 510 relative to the lightweight rotor hub 512 at max motor torque may cause no more than a five degree electrical phase shift.

FIG. 5B schematically shows an example of a rotor 550 including a magnet (e.g., a polar anisotropic ring magnet) coupled to a lightweight rotor hub including a drum and web portion. In rotor 550, a dimpled or corrugated structure 530 (e.g., a tolerance ring) is disposed between the magnet 510 and the drum portion of the rotor hub. As shown in FIG. 5B, the design of rotor 550 includes a lightweight rotor hub with a drum that does not include a relieved portion as shown in the example of FIG. 5A. Rather, the dimpled or corrugated structure 530 is used to reduce thermal stress at the interface between the magnet 510 and the lightweight rotor hub. It should be appreciated that any of the one or more further modifications to the drum portion of the lightweight rotor hub described in connection with the example rotor 500 of FIG. 5A may also be used with the example rotor 550 of FIG. 5B. For example, the drum portion of the rotor hub may be perforated with partial or complete through structures to reduce radial thickness, the drum may be bonded to the dimpled or corrugated structure 530 using a foaming adhesive, etc.

FIG. 6A shows an example stator 600 for use in an electric motor, in accordance with some embodiments of the present disclosure. Some conventional stator designs form the support structure as a set of segments, which are separately manufactured and then bonded together. The inventors have recognized and appreciated that segmenting may increase the cost of the stator due in part to the large number of parts that need to be handled and bonded together to form a ring. Additionally, bonding the segments may introduce tolerance issues and/or may result in a ring support structure that is fragile. In some embodiments, stator 600 includes a non-segmented structure 602 (also referred to herein as a “non-segmented metal support”) to address at least some of the deficiencies of a segmented structure described above. For instance, non-segmented structure 602 may be implemented as a laminated structure (e.g., a continuous laminated stack) or a bonded structure in which small pieces of steel are bonded and crushed together. Non-segmented structure 602 includes a set of teeth 610 and a set of slots 612 arranged between teeth in the set of teeth 610. In some embodiments, the set of teeth 610 in the non-segmented structure 602 are cut out (e.g., punched out, laser cut). In some embodiments, the material used to manufacture the non-segmented structure 602 comprises steel (e.g., high cobalt steel). Including a non-segmented structure 602 in stator 600 may reduce losses in the motor due to electrical bridging that may occur when individual metal pieces in segmented designs are bonded together. Additionally, including a non-segmented structure 602 in stator 600 may result in more precisely shaped teeth and slots in the stator compared with segmented designs, which may enable a tighter packing of coils in the slots, thereby improving the packing factor of the coils within the stator.

In the example stator 600, the non-segmented structure 602 includes 48 teeth. It should be appreciated, however, than any suitable number of teeth may be included in the non-segmented structure 602. The set of teeth 610 may include a plurality of teeth over which individual coils 614 in a set of coils may be placed (e.g., by sliding the coil over the tooth radial to the internal diameter of the stator 600). Some conventional stator designs include teeth with a flare portion at the end, resulting in T-shaped teeth. The flare may be configured to reduce eddy currents in the magnets of the rotor when the motor is operated at high speeds. For motors that are not configured to operate at high speeds most of the time (which may be the case in some robot applications in which the components of the robot may not always be moving), including such a flare on the end of teeth may not be needed, and the use of teeth with no flare on the end may provide other advantages, such as enabling a higher packing factor of coils in the slots of the stator. In some embodiments, the set of teeth may include teeth that do not have a flare on the end. Such teeth without a flare on the end may be referred to herein as “straight teeth.” It should be appreciated however that straight teeth may not be strictly straight, but may include a slight taper on one or both sides of tooth (e.g., a slight taper of up to 5 degrees along the length of the tooth).

Each coil 614 in the set of coils may comprise a copper coil pre-formed into a desired shape by a bending process, and the pre-formed coil may be slid over a top surface to reside in the open slots in the set of slots 612 between the set of teeth 610 as shown. Stator 600 includes 48 coils arranged within the set of slots 612 between the 48 teeth of the non-segmented structure 602. Each of the pre-formed coils 614 in the set of coils may be formed into a shape that includes a single layer of copper. For instance, in some embodiments, the coils may be formed into a single layer of copper using a casting or additive manufacturing technique. In other embodiments, the coils may be bent into a single layer of copper having a plurality of turns. In some embodiments, the number of turns in each coil 614 is less than fifteen turns, less than ten turns, or less than eight turns. It should be appreciated that the number of turns used for each coil may be determined, at least in part, on the pole count of the motor, the rotor geometry, the desired peak power of the motor, and the voltage available to provide power to the motor. For instance, if only higher voltages are available to power the motor, the number of turns may be increased. In some embodiments, each of the coils 614 is pre-formed from copper wire having a square or rectangular cross-section. The bending process may introduce a plurality of 180 degree turns in the copper wire to form the wire into the desired shape for the coil. In some embodiments, the copper wire may be overbent to account for springback along the length of the coil. When rectangular copper wire is used, the wire may be bent on the “short edge” of the copper wire or on the “long edge” of the copper wire. It may be advantageous in some embodiments to bend the wire on the long edge to permit a smaller number of turns in the wire. In some embodiments, copper wire with a circular cross section may be used instead of square or rectangular wire to form the coils. The packing factor when circular wire is used to form the coils may be improved by compressing and/or plastically deforming the circular wire after forming the bends. In some embodiments, the individual coils 614 may be pre-formed using a casting or additive manufacturing (e.g., 3D printing) technique. In some embodiments, the coils may be skewed to allow for an extra turn, thereby improving the packing factor of copper in the slots of the stator.

The inventors have recognized and appreciated that pre-forming individual coils and sliding them over teeth of the stator may improve the packing factor (also referred to herein as the “fill factor”) of copper in the stator relative to conventional coil winding techniques (e.g., machine-based winding techniques) in which a gap between teeth is required to thread the coil in during winding. Increasing the packing factor of copper in the slots of the stator in accordance with some embodiments may improve the peak torque that can be provided by the motor architecture and/or may reduce the thermal resistance between the motor windings and the non-segmented structure, thereby allowing the motor to operate at a cooler temperature. In some embodiments, the packing factor of copper in the slots of the stator may be increased by using coils having at least two types of shapes. For instance, in some embodiments the set of coils may include trapezoidal-shaped coils (not shown) and straight coils. By placing trapezoidal-shaped coils next to straight coils in the slots of the stator and repeating this alternating pattern around the circumference of the rotor, more copper may be packed in the slots resulting in a higher fill factor. FIG. 6C shows an example of a stator 650 having trapezoidal-shaped coils 660 alternating with straight coils 670 arranged in the slots of the stator around the circumference of the stator. In some embodiments, the fill factor of the slots in the stator may exceed 60%, exceed 70%, exceed 80%, etc.

FIG. 6B shows an example stator 620 for use in an electric motor, in accordance with some embodiments of the present disclosure. Similar to stator 600, stator 620 includes a non-segmented structure having a set of straight teeth with open slots between the teeth. In the example stator 620, the non-segmented structure includes 24 teeth. Stator 620 also includes a set of 24 pre-formed copper coils placed over the set of teeth such that the copper coils are arranged in the open slots between the teeth to achieve a high packing factor. As shown in FIG. 6B, each of the coils includes a set of leads (e.g., two leads) 630. Accordingly, in the example stator 620, the set of coils includes 48 leads.

FIG. 7 shows an example stator 700 in which the set of leads 730 of the set of coils 614 are electrically coupled to a printed circuit board 710. In some embodiments, the printed circuit board 710 may include, for each pair of leads corresponding to a single coil, a corresponding pair of notches 720A, 720B. The leads 630 of the set of coils 614 may be arranged in the notches 720A, 702B prior to affixing (e.g., soldering) the set of leads 730 to the printed circuit board 710. FIG. 7 shows the assembled (e.g., soldered) stator in which the notches 720A, 720B are soldered to the leads 630. Prior to assembly, notches 720A, 720B may be open notches within which the leads 630 may be arranged. In some embodiments, the printed circuit board 710 may be used to electrically couple multiple of the coils in series and/or in parallel. For instance, in one implementation, the coils may be connected in a wye configuration, such that every third coil is coupled in series to produce a three phase motor. In some embodiments, the coils may be connected in a delta configuration. Each of the coupled groups of coils may be associated with a control pin on the printed circuit board 710. For example, as shown in FIG. 7, a first control pin 712 may be coupled to a first group of series connected coils, a second control pin 714 may be coupled to a second group of series connected coils, and third control pin 716 may be coupled to a third group of series connected coils. In this way, the printed circuit board may also be referred to herein as a “phase board” or phase PCB. By connecting each of the phases of the motor in series (e.g., using a wye configuration), currents that may be induced within loops of the motor due to manufacturing variances of the motor components may be avoided. Using a wye configuration to connect the leads of the coils may also enable the use of copper wire with a large cross section and/or using a small number of turns to form the coil. In some embodiments, the leads of the coils may be chamfered to facilitate assembly of the leads with the printed circuit board.

The inventors have recognized and appreciated that an advantage of the stator design described herein, is that the same coil arrangement may be used for different applications/parts of the robot by coupling the coils to different phase boards that electrically couple different groups of coils as desired. For instance, different phase boards may be used to change the torque constant (Kt) used for motors in different parts of the robot to enable flexibility of motor design for actuating robot joints that require more power or less power. Including such redundancy may improve the manufacturability of the actuators for inclusion in a robot.

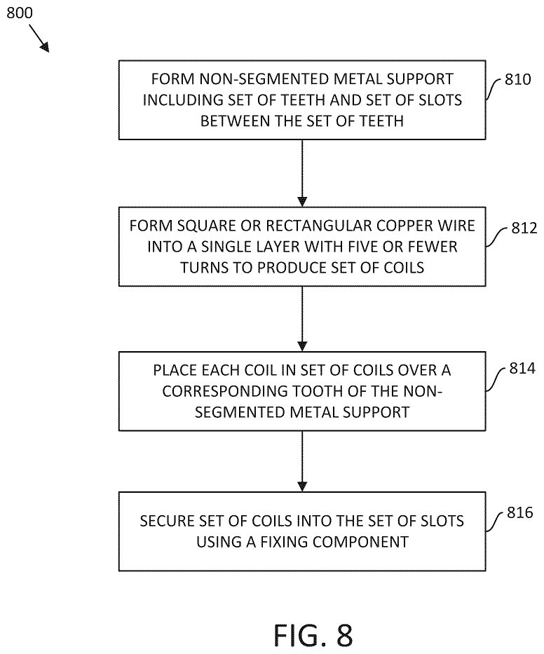

FIG. 8 illustrates a process 800 for manufacturing a stator for an electric motor in accordance with some embodiments. Process 800 may begin in act 810, where a non-segmented metal support including a plurality of teeth (e.g., teeth without a flare on the end) and a set of slots between the set of teeth may be formed. For instance, the non-segmented support may comprise a continuous laminated metal stack. As described above, forming the metal support from a single piece of material may provide some advantages (e.g., lower resistive losses, greater strength, lower cost, etc.) compared with segmented designs in which the individual teeth of the stator are formed and wound separately and then assembled. Process 800 may then proceed to act 812, where square or rectangular copper wire is formed into a single layer with fifteen or fewer turns to produce a set of pre-formed coils. The number of coils formed in act 812 may correspond to the number of teeth included in the non-segmented metal support formed in act 810. Process 800 may then proceed to act 814, where each coil in the set of coils is placed over a corresponding tooth of the non-segmented metal support, such that the coils reside in the set of slots between the set of teeth. Process 800 then proceeds to act 816, where the set of coils is secured into the set of slots using a fixing component. As discussed in connection with FIG. 7, in some embodiments, the leads of each of the coils may be fixed (e.g., soldered) to slots in a printed circuit board as the fixing component. In some embodiments, a thermally conductive epoxy may be used as the fixing component to pot the coils into the set of slots prior to coupling the coils to a printed circuit board. In some embodiments, the fixing component may include an end cap arranged on the stator assembly to secure the set of coils into the set of slots. Although different fixing components are described, it should be appreciated that multiple fixing components (e.g., epoxy and printed circuit board) may be used in some embodiments.

A number of implementations have been described. Nevertheless, it will be understood that various modifications may be made without departing from the spirit and scope of the disclosure.

1. An electric motor for a mobile robot, the electric motor comprising:
a rotor including a rotor hub and a magnetic structure coupled to the rotor hub, wherein the magnetic structure is configured to provide an active surface, the active surface including a circular array of radial magnetic poles of alternating polarity;
a stator comprising a non-segmented structure including a set of teeth and a set of slots arranged between individual teeth of the set of teeth, wherein each tooth of the set of teeth has a surface over which a respective coil is configured to be placed within adjacent slots of the tooth;
a set of coils arranged within the set of slots of the stator; and
a printed circuit board electrically coupled to each of the coils in the set of coils.

2. The electric motor of claim 1, wherein the active surface is an outside diameter of the rotor.

3. The electric motor of claim 1, wherein the active surface is an inside diameter of the rotor.

4. The electric motor of claim 1, wherein the magnetic structure includes a set of permanent magnets arranged around the rotor hub in a Halbach array.

5. The electric motor of claim 4, wherein the set of permanent magnets includes at least two types of magnets magnetized in different orientations, wherein the at least two types of magnets are arranged around the rotor in a repeating sequence.

6. The electric motor of claim 5, wherein the set of permanent magnets includes at least five types of magnets magnetized in different orientations, wherein the at least five types of magnets are arranged around the rotor in a repeating sequence.

7. The electric motor of claim 4, wherein the set of permanent magnets comprises a set of sintered rare-earth magnets.

8. The electric motor of claim 7, wherein the set of sintered rare-earth magnets includes a set of samarium-cobalt magnets or a set of NbFeB magnets.

9. The electric motor of claim 4, wherein the set of permanent magnets are arranged to form at least ten pole pairs.

10. The electric motor of claim 1, wherein the magnetic structure is configured to provide an active surface having a number of pole pairs greater than X, where X is 2*sqrt (diameter of active surface).

11. The electric motor of claim 1, wherein the magnetic structure includes a polar anisotropic ring magnet.

12-24. (canceled)

25. The electric motor of claim 1, wherein the set of teeth of the stator comprises a set of straight teeth.

26. (canceled)

27. The electric motor of claim 1, wherein each coil in the set of coils includes fifteen or fewer turns.

28. (canceled)

29. The electric motor of claim 1, wherein the set of coils includes a trapezoidal shaped coil and a straight coil.

30. The electric motor of claim 29, wherein the set of coils includes trapezoidal shaped and straight coils alternating around a circumference of the stator.

31. (canceled)

32. The electric motor of claim 1, further comprising an epoxy configured to pot the set of coils into the set of slots of the stator.

33. The electric motor of claim 1, wherein the printed circuit board is configured to electrically couple groups of coils in the set of coils in series and/or parallel in a delta configuration or a wye configuration.

34. (canceled)

35. The electric motor of claim 1, wherein each of the coils includes a lead configured to be inserted into a corresponding radial slot in the printed circuit board.

36-38. (canceled)

39. A robot, comprising:
a set of joints; and
a set of electric motors associated with the set of joints, wherein the set of electric motors includes a first electric motor comprising:
a rotor including a rotor hub and a magnetic structure coupled to the rotor hub, wherein the magnetic structure is configured to provide an active surface, the active surface including a circular array of radial magnetic poles of alternating polarity;
a stator comprising a non-segmented structure including a set of teeth and a set of slots arranged between individual teeth of the set of teeth, wherein each tooth of the set of teeth has a surface over which a respective coil is configured to be placed within adjacent slots of the tooth;
a set of coils arranged within the set of slots of the stator; and
a printed circuit board electrically coupled to each of the coils in the set of coils.

40. The robot of claim 39, wherein the magnetic structure includes a set of permanent magnets arranged around the rotor hub in a Halbach array.
